(19) United States
(12) Patent Application Publication
(10) Pub. No.: US 2023/0098284 A1
(43) Pub. Date: Mar. 30, 2023

(54) METHOD FOR GENERATING TRAINING DATA FOR SUPERVISED LEARNING FOR TRAINING A NEURAL NETWORK

(71) Applicant: Robert Bosch GmbH, Stuttgart (DE)

(72) Inventors: Andras Gabor Kupcsik, Boeblingen (DE); Philipp Christian Schillinger, Renningen (DE); Alexander Kuss, Schoenaich (DE); Anh Vien Ngo, Nehren (DE); Miroslav Gabriel, Muenchen (DE); Zohar Feldman, Haifa (IL)

(21) Appl. No.: 17/935,496

(22) Filed: Sep. 26, 2022

(30) Foreign Application Priority Data
Sep. 30, 2021 (DE) 10 2021 210 993.4

(51) Int. Cl. G06V 10/774; G06V 10/82; G06V 10/22

(52) U.S. Cl. CPC G06V 10/774; G06V 10/82; G06V 10/22; G06V 2201/07

(57) ABSTRACT

A method for generating training data for supervised learning for training a neural network to identify, from digital images of objects, locations of the objects for interacting with the objects. The method includes: acquiring, for each training object, at least one digital reference image and a plurality of further images of the training object; for each training object, specifying a location of the training object, mapping the at least one reference image onto a descriptor image, identifying descriptors of the specified location, mapping the further images of the training object onto further descriptor images, and determining locations in the further images by locating points in the further images, the descriptors of which in the further descriptor images correspond to the specified descriptors of the at least one specified location; and generating the training data for supervised learning by marking the determined locations for the further images of the training objects.

### CROSS REFERENCE

The present application claims the benefit under 35 U.S.C. § 119 of German Patent Application No. DE 10 2021 210 993.4 filed on Sep. 30, 2021, which is expressly incorporated herein by reference in its entirety.

### FIELD

The present invention relates to methods for generating training data for supervised learning for training a neural network to identify, from digital images of objects, locations of the objects for interacting with the objects.

### BACKGROUND INFORMATION

In order to enable flexible production or processing of objects by a robot, it is desirable for the robot to be capable of picking up (e.g., gripping) an object, regardless of the position at which the object is placed in the working space of the robot, and also to be capable of picking up variants of the object that have not yet been observed.

When removing objects from a container using a robot (bin picking), for example, there are several methods for recognizing the most promising places for the gripping in order to successfully remove an object from the container. These methods typically operate with color (e.g., RGB) and depth images of the relevant scenario, in some cases either color or depth images being sufficient. In addition, most of these approaches are based on AI methods, e.g., the use of neural networks for learning an association between input data and promising gripping points. One difficulty with these approaches is the generalization of different inputs, e.g., new scenes/backgrounds, new shapes of objects, different appearance/colors of objects, etc. This is all the more important if the networks are trained on the basis of synthetic data, e.g., in a simulation or an image reproduction engine, since these data differ in nature from real images. On the other hand, it is very laborious to obtain and mark real data in large numbers for the training (i.e., to provide them with ground truth information), in particular for the recognition of locations for gripping (or generally picking up, for example also suctioning).

Accordingly, methods for generating training data that enable effective training of neural networks for recognizing locations of objects for picking up (or generally interacting) are desirable.

### SUMMARY

In accordance with various example embodiments of the present invention, a method for generating training data for supervised learning for training a neural network to identify, from digital images of objects, locations of the objects for interacting with the objects is provided, comprising: acquiring, for each of a plurality of training objects, at least one digital reference image and a plurality of further images of the training object; for each training object, specifying at least one location of the training object, mapping the at least one reference image onto a descriptor image, identifying descriptors of the at least one specified location, mapping the further images of the training object onto further descriptor images, and determining locations in the further images by locating points in the further images, the descriptors of which in the further descriptor images correspond to the identified descriptors of the at least one specified location; and generating the training data for supervised learning by marking the determined locations for the further images of the training objects.

The method according to example embodiments of the present invention described above enables more robust training of a neural network for recognizing regions for picking up an object or generally interacting with an object (e.g., in order to fasten something to it, label it, cut it, etc.). By means of the training data generated according to the method described above, better generalization of simpler geometries to more complex geometries or new types of objects is achieved than during training of conventionally generated synthetic data, since the sim-to-real transfer hurdle must be overcome in the latter case.

As a result, the method described above enables improved recognition of locations or regions for interacting with an object.

The marking of the digital images (i.e., the training input data) by means of target outputs via the path of descriptor images (e.g., determined by means of a dense object net) makes it possible for most markings (labels) to be determined automatically or in a self-monitored manner, which increases the data efficiency, which is a typical problem in deep learning.

According to an example embodiment of the present invention, the trained neural network performs an inference that is used to detect locations or regions or also poses for picking up objects. This takes place in a model-free manner, i.e., solely by assessing the pick-up ability of locations of the object from the input images (e.g., RGB and depth input or only from the depth) instead of the comparison with a target object model. For this purpose, the neural network can be combined with further processing steps. The determination of the pick-up pose is relevant for applications, for example, in which a robot removes objects from a container, in order to plan the actions for the pick-up accordingly. The recognition or determination of locations or regions (or ultimately of the pose) for picking up can also be relevant for further robot applications, for example, for assembling where a robot must grip objects. Applications are not limited to gripping by robots, but can also include other applications that require model-free identification of certain regions or surface parts of objects.

Various embodiment examples of the present invention are specified below.

Embodiment example 1 is a method for generating training data for supervised learning for training a neural network as described above.

Embodiment example 2 is a method according to exemplary embodiment 1, wherein the marking of the identified locations for the further images comprises the generation of target data for the neural network for the further images which identify the determined locations.

The target data may then be used as a ground truth (i.e., labels) for supervised learning.

Embodiment example 3 is a method according to embodiment 1 or 2, wherein the target data specify a quality of the interaction with the object for points of the object in the relevant further image.

This enables the selection of locations or regions for interacting with the object by suitable post-processing, which can also, for example, take into account the required size of the regions, for example, depending on the device used for picking up the object.

Embodiment example 4 is a method according to any of embodiment examples 1 to 3, comprising mapping the at least one reference image onto the descriptor image and the further images onto the further descriptor images by means of a dense object net.

A dense object net can be automatically trained for a given class of objects without manual marking of input training data. It is therefore suitable for generating target data without even the generation of additional target data being necessary for this purpose.

Embodiment example 5 is a method according to any of embodiment examples 1 to 4, wherein the specified location is a location suitable for interacting with the training object or is a location that is not suitable for interacting with the training object.

The neural network can thus be trained to recognize locations which are suitable for interacting and/or to recognize locations which are not suitable for interacting, i.e., which are to be avoided (e.g., sensitive locations). In both cases, the neural network ultimately identifies locations suitable for interacting (by excluding those that are not suitable).

Embodiment example 6 is a method according to any of embodiment examples 1 to 5, comprising specifying the at least one location in the at least one reference image according to a user input identifying the at least one location.

This allows expert knowledge to be incorporated into the training in a simple manner, that is then automatically transmitted to all training data to enable robust training.

Embodiment example 7 is a method according to any of embodiment examples 1 to 6, comprising:

acquiring a plurality of reference images for each training object, wherein the reference images show the training object in different views, and, for each training object,
specifying the at least one location in each of the reference images;
mapping each reference image onto a relevant descriptor image; and
identifying the descriptors of the at least one specified location by means of the descriptor images.

This ensures that the neural network can identify locations on different sides of objects.

Embodiment example 8 is a method for training a neural network, comprising:

generating training data according to any of embodiment examples 1 to 7; and training the neural network by means of the generated training data.

Embodiment example 9 is a method for controlling a robot device, comprising:

training a neural network according to embodiment example 8; acquiring at least one image of an object with which the robot device is to interact;

feeding the image to the neural network; and controlling the robot device taking into account the output of the neural network.

Embodiment 10 example is a control device which is configured to perform a method according to any of embodiment examples 1 to 9.

Embodiment example 11 is a computer program with commands which, when executed by a processor, cause the processor to perform a method according to any of embodiment examples 1 to 9.

Embodiment example 12 is a computer readable medium that stores commands that, when executed by a processor, cause the processor to perform a method according to any of embodiment examples 1 to 9.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a robot, according to an example embodiment of the present invention.

FIG. 2 illustrates the generation of a target output for a training input data set, according to an example embodiment of the present invention.

FIG. 3 shows a flowchart depicting a method for generating training data for supervised learning for training a neural network according to one embodiment of the present invention.

### DETAILED DESCRIPTION OF EXAMPLE EMBODIMENTS

The following detailed description relates to the accompanying figures, which show, by way of explanation, specific details and aspects of this disclosure in which the present invention can be executed. Other aspects may be used and structural, logical, and electrical changes may be performed without departing from the scope of the present invention. The various aspects of this disclosure are not necessarily mutually exclusive, since some aspects of this disclosure may be combined with one or more other aspects of this disclosure to form new aspects of the present invention.

Various examples are described in more detail below.

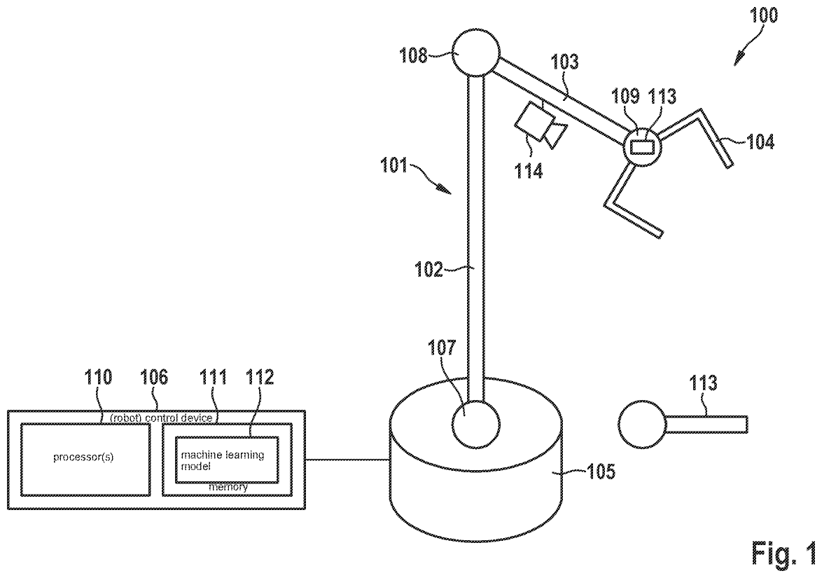

FIG. 1 shows a robot 100.

The robot 100 includes a robot arm 101, for example, an industrial robot arm for handling or assembling a work piece (or one or more other objects). The robot arm 101 includes manipulators 102, 103, 104 and a base (or support) 105 by means of which the manipulators 102, 103, 104 are supported. The term “manipulator” refers to the movable components of the robot arm 101, the actuation of which enables physical interaction with the environment, for example to execute a task. For control, the robot 100 includes a (robot) control device 106, which is designed to implement the interaction with the environment according to a control program. The last component 104 (which is farthest away from the support 105) of the manipulators 102, 103, 104 is also referred to as the end effector 104 and may include one or more tools such as a welding torch, a gripping instrument, a painting apparatus or the like.

The other manipulators 102, 103 (located closer to the support 105) may form a positioning device such that, together with the end effector 104, the robot arm 101 is provided with the end effector 104 at its end. The robot arm 101 is a mechanical arm that can provide similar functions to a human arm (possibly with a tool at its end).

The robot arm 101 may include joint elements 107, 108, 109 that connect the manipulators 102, 103, 104 to each other and to the support 105. A joint element 107, 108, 109 may have one or more joints that may each provide a rotatable movement (i.e., rotational movement) and/or translational movement (i.e., displacement) for associated manipulators relative to each other. The movement of the manipulators 102, 103, 104 can be initiated by means of actuators which are controlled by the control device 106.

The term “actuator” may be understood as a component that is designed to bring about a mechanism or process in response to its drive. The actuator can implement instructions (called activation) generated by the control device 106 as mechanical movements. The actuator, for example, an electromechanical converter, can be designed to convert electrical energy into mechanical energy in response to its drive.

The term “controller” may be understood as any type of logic-implementing entity that may include, for example, a circuit and/or processor that is capable of executing software, firmware, or a combination thereof stored in a storage medium, and that may issue instructions, e.g., to an actuator in the present example. The controller may be configured, for example, by program code (e.g., software) to control operation of a system, in the present example a robot.

In the present example, the controller 106 includes one or more processors 110 and a memory 111 that stores code and data, based on which the processor 110 controls the robot arm 101. According to various embodiments, the control device 106 controls the robot arm 101 based on a machine learning model 112 stored in the memory 111.

According to various embodiments, the machine learning model 112 is designed and trained to enable the robot 100 to recognize a location of an object 113 at which the robot 100 can pick up the object 113 (or can interact with it in some other way, e.g., painting).

The robot 100 may, for example, be equipped with one or more cameras 114 that enable it to record images of its working space. The camera 114 is fastened to the robot arm 101, for example, so that the robot can record images of the object 113 from various perspectives by moving the robot arm 101.

According to various embodiments, the machine learning model 112 is a neural network 112 and the control device 106 feeds the neural network 112 one or more digital images (color images, depth images, or both) of an object 113, and the neural network 112 is configured to specify locations (or regions) of the object 113 that are suitable for picking up the object 113. For example, the neural network may correspondingly segment an input image showing the object 113, e.g., assign a value (“pick-up quality value”) to each pixel indicating how well the pixel is suited for picking up. The control device 106 can then choose a region of sufficient size as a point for picking up, in which region these values are sufficiently high (for example, are above a threshold value, are at the maximum on average, etc.).

Various architectures that use an image input may be used for the neural network 112. Examples include fully convolutional networks (e.g., UNet, ResNet), which assign a value (which indicates the suitability of the relevant location for picking up the object shown) to each pixel of an input image in order to form an output image of the same size as the input image. This enables further processing of the output for determining a pick-up pose, e.g., by selecting a global maximum in the output image.

For this purpose, it is necessary to train the neural network 112 accordingly. To this end, training data are in turn required, that is to say a set of training data elements which each comprise input data of the neural network (one or more images) and an associated target output (i.e., ground truth), i.e., they must be provided with a target output (labeled, i.e., marked). These can be generated from real scenarios, which, however, is laborious, or generated synthetically (i.e., by simulation). However, training with real generated training data is typically much more effective than training with synthetic training data (known as “sim-to-real gap”).

According to various embodiments, real data (i.e., real images) of (training) objects are automatically marked (i.e., provided with ground truth labels). For this purpose, a training input data set (e.g., color and depth images) is collected which contains a set of known training objects with comparatively simple geometries. For (supervised) training, for each element of the training input dataset (i.e., a possible training input of the neural network), e.g., a training input image or a plurality of training input images (e.g., with RGB channels and a depth channel or also an RGB image and a depth image in another resolution), a target output (e.g., a pixel-by-pixel segmentation for an input image) is generated, which specifies preferred regions or locations for picking up. This target output together with the training input then forms a training element and the neural network is trained by means of these training data (which contain the training element) by means of supervised training.

According to various embodiments, the target output is generated using color images (e.g., RGB data). For this purpose, regions on the surfaces of known (training) objects which are well suited for picking up are specified manually (by a user) (which can also be done indirectly by marking those which are poorly suitable). By detecting these regions in the training input images, the regions in the training input images can be marked automatically. A suitable method for such a detection is the mapping of images onto descriptor images, for example, by means of a dense object net.

A dense object net (DON) maps an image onto any dimensional (dimension D) descriptor spatial image. The dense object net is a neural network trained using self-supervised learning to output a descriptor spatial image for an input image of an image. Thus, images of known objects may be mapped onto descriptor images that contain descriptors that identify locations on the objects regardless of the perspective of the image. Thus, training data for the neural network 112 can be generated by specifying the regions for picking up only in a small number of images while the other training input images can be automatically marked.

In the following, an embodiment example for generating training data for supervised learning for training a neural network is described for detecting locations for picking up an object. The output of the neural network in the inference depends on the target data (labels) used during training. The described method for generating training data thus determines what the neural network detects during the application and consequently, for example, at which location a robot 100 attempts to pick up an object 113.

The basis for the generated set of training data is a set of training objects, which are preferably similar to the objects that are to be picked up in the application, but have a relatively simple geometry and have clearly recognizable different textures.

For an application for picking up objects from a container, for example, a training input data set is recorded by placing random objects in different arrangements in containers, similar to how it is expected during operation. Digital images with color and depth information (RGB+D) are recorded in the same way (e.g., by the camera 114) as in operation. These images form the training input data set, and it will be explained below how target outputs (labels) are added to this training input data set.

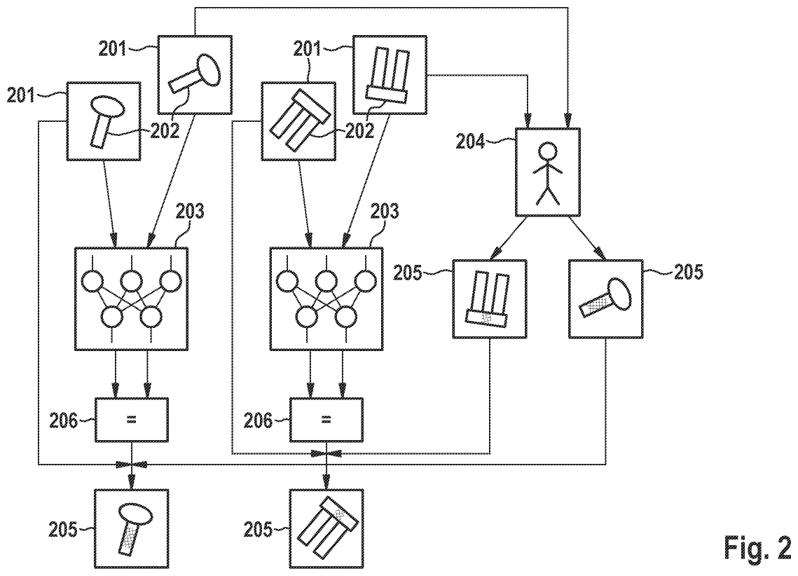

FIG. 2 illustrates the generation of a target output for a training input data set.

As explained above, the training input data set is digital images 201 which show various objects 202 in various orientations and/or positions. These objects are used for training and can therefore also be regarded as training objects 202.

To be able to be used for supervised training, a target output 205 should be assigned to each element of the training input data set (e.g., an RGB+D image), which makes it possible to distinguish locations or regions of the (training) object shown in the relevant image that are suitable for picking up the object from those that are not suitable for picking up the object.

The target output 205 contains, for example, one marking per pixel of the input image as to whether the pixel belongs to a region which is suitable for picking up the object, or it is also possible that no marking exists for certain pixels.

All markings may denote regions that are suitable for picking up the object, and the absence of a marking is interpreted such that the pixel belongs to a region that is not suitable for picking up, or vice versa. If both pixels belonging to regions that are suitable for picking up and pixels belonging to regions that are not suitable for picking up are explicitly marked, a missing marking can be interpreted as an unknown value.

For the supervised training, a suitable loss function can be selected, e.g., a BCE (binary cross-entropy) loss or a RMSE (root mean squared error) loss, in which markings are mapped onto certain pick-up quality values (output by the neural network). In order to deal with unknown values due to lack of explicit markings, the loss is applied, for example, only to a masked version of the image, which ignores non-marked pixels.

In the case of simple object geometries, the target outputs from the depth image can be generated using simple processing methods, for example, by determining how flat the surface of an object is or by fitting geometric primitives.

In the case of more complex object geometries or pick-up region geometries, the target outputs can be obtained by tracking (e.g., manually) selected pick-up regions on the surface via the images in the training input data set.

For this purpose, a further neural network 203 is trained for each (or a subset) of the objects 202. This further neural network 203 tracks the selected regions which were manually selected in few images.

Dense object nets can be used as the further neural networks 203. A dense object net can be trained in a self-supervising manner for each object 202 without further information. It is trained to map points on the surface of the object, which is shown in an image 201, onto unambiguous, perspective-independent descriptors.

Training of the further neural networks 203 requires little additional effort, since it is possible in a self-supervising manner (and thus without significant manual effort) and the set of objects 202 is known. The set of objects can also be selected such that the training provides good results with regard to the fact that the (further) neural networks 203 have a high accuracy (i.e., output the same descriptors for the same locations of the object for all images).

This allows (training) target data to be generated in the following manner
(1) A (reference) image is mapped onto a descriptor image for each (training) object by the relevant further neural network 203.
(2) The user 204 selects points (e.g., by clicking) on the image for each object 202 in that the user 204 specifies, for example, the corners of a polygon region or selecting points within a convex envelope. And the descriptor of each selected point is registered.
(3) Depending on the selection of the user, the points are marked as points of a region that is suitable for picking up, or as points of a region that is not suitable for picking up.
(4) (2) and (3) are repeated until the points of all desired regions are marked.
(5) (1) to (4) can be repeated for multiple images in order to cover all sides of an object 202.
(6) For each remaining image 202 in the data set and each further neural network 203,
   a. the further network determines a descriptor image
   b. it is determined where the marked regions in the image are by comparing 206 the descriptors in the descriptor image with the registered descriptors
   c. the pixels of the regions are marked accordingly (as marked by the user in the reference image according to the selection)

It should be noted for (3) that different types of pick-up devices (e.g., end effectors) can be used depending on the application, such as a pincer gripper or a suction device. Finally, it is the user who selects where and how regions are marked on the objects 202, but the requirements of the various pick-up devices (especially size of the region used for picking up) can be taken into account. If necessary, the target data (e.g., markings of pixels) can contain additional properties such as, for example, a rotation angle for asymmetrical pick-up devices (e.g. per pick-up region or pick-up location) or the target width for the pincers of a gripper. Since only a small number of images need be manually annotated, the approach described above accounts for detailed target data for an object in a (reference) image, which are then automatically transmitted to the other (further) images of the object. The target data are then added to all training input data (e.g., training images) in order to form the training data and to train the neural network (e.g., the neural network 112) for detection.

The comparison in (6)b is used to find the plurality of reference points pᵢ, i=1, . . . , N selected on the training object in (2) (e.g., corner points of a location for picking up the object or all points that belong to a region for picking up the object) in the further images of the object. In (2), the descriptors of these reference points are also determined.

For this purpose, the user selects in (2) reference pixels (uᵢ, vᵢ) on the object (and thus, accordingly, reference points of the object) in a reference image of the object and the reference image is mapped by the relevant neural network 203 onto a descriptor image. Then, the descriptors at the positions in the descriptor image, which are given by the positions of the reference pixels, can be taken as descriptors of the reference points, that is to say the descriptors of the reference points are dᵢ=I^{d}(uᵢ, vᵢ), where I^{d}=f(I; θ) is the descriptor image, where f is the mapping implemented by the neural network (from the camera image onto the descriptor image), I is the camera image, and e is the weights of the relevant neural network 203.

If, in one of the other images I_{new} of the training object, the object is now in an unknown position, this image is mapped in 6(a) by means of the neural network onto an associated descriptor image I^{d}_{new}=f(I_{new}; θ). In this new descriptor image, descriptors are now searched for which are as close as possible to the dᵢ descriptors of the reference image, for example by (uᵢ, vᵢ)*=argmin_{ui,vi}∥I^{d}_{new}(uᵢ,vᵢ)−dᵢ∥₂² for all i=1, . . . , N.

In this case, a bound can also be provided, so that it is decided, for example, that a reference point pᵢ is not seen in the image I_{new} when∥I^{d}_{new} (uᵢ,vᵢ)−dᵢ∥₂ for all pixels of the image I_{new} is above the bound.

The position of the location or of the region for picking up the object, which the user has selected, is determined in the image I_{new} from the thus determined or estimated positions (uᵢ, vᵢ)* of the reference points in the descriptor image I^{d}_{new} (and thus accordingly in the image I_{new}). Corresponding target data for the neural network 112 to be trained are then generated in (6)c for the image I_{new} (i.e., the image I_{new} is marked or labeled accordingly).

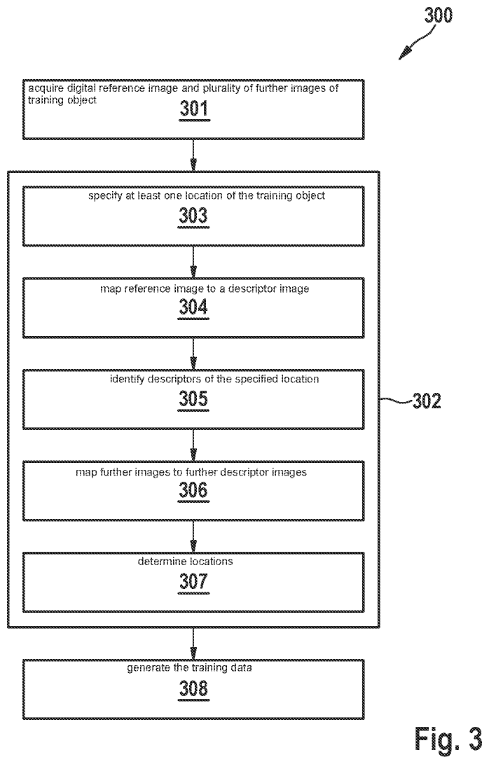

In summary, according to various embodiments, a method is provided as shown in FIG. 3.

FIG. 3 shows a flow chart 300 depicting a method for generating training data for supervised learning for training a neural network to identify, from digital images of objects, locations of the objects for interacting with the objects, according to one embodiment.

In 301, for each of a plurality of training objects, at least one digital reference image and a plurality of further images of the training object are acquired.

In 302, for each training object,
at least one location of the training object is specified in 303 (e.g., by user input);
the at least one reference image is mapped onto a descriptor image in 304;
descriptors of the at least one specified location are identified in 305;
the further images of the training object are mapped onto further descriptor images in 306; and
in 307, locations in the further images are determined by locating points in the further images, the descriptors of which in the further descriptor images correspond to the identified descriptors of the at least one specified location.

In 308, the training data for supervised learning are generated by marking the determined locations for the further images of the training objects.

The method of FIG. 3 may be performed by one or more computers with one or more data processing units. The term “data processing unit” may be understood as any type of entity that enables processing of data or signals. The data or signals can be treated, for example, according to at least one (i.e., one or more than one) specific function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way to implement the respective functions described in more detail herein may also be understood as a data processing unit or logic circuitry. One or more of the method steps described in detail here can be executed (e.g., implemented) by a data processing unit by one or more specific functions that are performed by the data processing unit.

The approach of FIG. 3 may be used to generate training data for a machine learning model, which in turn is used to generate a control signal for a robot device. The term “robot device” may be understood to refer to any physical system (with a mechanical part of which the movement is controlled), such as a computer-controlled machine, a household appliance, an electric tool, a manufacturing machine, or a personal assistant.

For example, color and depth images are used as input data for the machine learning model. However, these can also be supplemented by sensor signals from other sensors such as, for example, radar, lidar, ultrasound, movement, thermal images, etc.

Embodiments may be used to train a machine-learning system and control a robot, e.g., autonomously by robot manipulators, to achieve various manipulation tasks in different scenarios. In particular, embodiments are applicable to the control and monitoring of the execution of manipulation tasks, for example, in assembly lines.

Although specific embodiments have been depicted and described herein, a person skilled in the art will recognize that the specific embodiments shown and described may be replaced with a variety of alternative and/or equivalent implementations without departing from the scope of the present invention. This application is intended to cover any adaptations or variations of the specific embodiments discussed herein.

What is claimed is:

1. A method for generating training data for supervised learning for training a neural network to identify, from digital images of objects, locations of the objects for interacting with the objects, comprising:
acquiring, for each of a plurality of training objects, at least one respective digital reference image and a plurality of respective further images of the training object;
for each training object of the plurality of training objects:
specifying at least one location of the training object,
mapping the at least one respective reference image onto a descriptor image,
identifying descriptors of the at least one specified location,
mapping the respective further images of the training object onto further descriptor images, and
determining locations in the respective further images by locating points in the further images, the descriptors of which in the further descriptor images correspond to the identified descriptors of the at least one specified location; and
generating the training data for supervised learning by marking the determined locations for the respective further images of the training objects.

2. The method according to claim 1, wherein the marking the identified locations for the respective further images includes generating target data for the neural network for the further images that identify the determined locations.

3. The method according to claim 2, wherein the target data specify a quality of an interaction with each object for points of the object in each respective further image.

4. The method according to claim 1, wherein the mapping of the at least one respective reference image onto the descriptor image and the mapping of the respective further images onto the further descriptor images is performed using a dense object net.

5. The method according to claim 1, wherein the specified location is a location that is suitable for interacting with the training object or is a location that is not suitable for interacting with the training object.

6. The method according to claim 1, wherein the specifying of the at least one location in the at least one reference image is according to a user input that identifies the at least one location.

7. The method according to claim 1, further comprising:
acquiring a plurality of respective reference images for each training object, wherein the respective reference images show the training object in different views, and, for each training object,
specifying the at least one location in each of the respective reference images;
mapping each reference image onto a relevant descriptor image; and
identifying the descriptors of the at least one specified location using the descriptor images.

8. A method for training a neural network, comprising the following steps:
generating training data for generating training data for supervised learning for training the neural network to identify, from digital images of objects, locations of the objects for interacting with the objects, including:
acquiring, for each of a plurality of training objects, at least one respective digital reference image and a plurality of respective further images of the training object;
for each training object of the plurality of training objects:
specifying at least one location of the training object,
mapping the at least one respective reference image onto a descriptor image,
identifying descriptors of the at least one specified location,
mapping the respective further images of the training object onto further descriptor images, and
determining locations in the respective further images by locating points in the further images, the descriptors of which in the further descriptor images correspond to the identified descriptors of the at least one specified location; and
generating the training data for supervised learning by marking the determined locations for the respective further images of the training objects; and
training the neural network using the generated training data.

9. A method for controlling a robot device, the method comprising the following steps:
training a neural network by:
generating training data for generating training data for supervised learning for training the neural network to identify, from digital images of objects, locations of the objects for interacting with the objects, including:
acquiring, for each of a plurality of training objects, at least one respective digital reference image and a plurality of respective further images of the training object;
for each training object of the plurality of training objects:
specifying at least one location of the training object,
mapping the at least one respective reference image onto a descriptor image,
identifying descriptors of the at least one specified location,
mapping the respective further images of the training object onto further descriptor images, and
determining locations in the respective further images by locating points in the further images, the descriptors of which in the further descriptor images correspond to the identified descriptors of the at least one specified location; and
generating the training data for supervised learning by marking the determined locations for the respective further images of the training objects; and
training the neural network using the generated training data;
acquiring at least one image of a first object with which the robot device is to interact;
feeding the image to the neural network; and
controlling the robot device taking into account output of the neural network.

10. A control device configured to generating training data for supervised learning for training a neural network to identify, from digital images of objects, locations of the objects for interacting with the objects, comprising:
acquiring, for each of a plurality of training objects, at least one respective digital reference image and a plurality of respective further images of the training object;
for each training object of the plurality of training objects:
specifying at least one location of the training object,
mapping the at least one respective reference image onto a descriptor image,
identifying descriptors of the at least one specified location,
mapping the respective further images of the training object onto further descriptor images, and
determining locations in the respective further images by locating points in the further images, the descriptors of which in the further descriptor images correspond to the identified descriptors of the at least one specified location; and
generating the training data for supervised learning by marking the determined locations for the respective further images of the training objects.

11. A non-transitory computer-readable medium on which is stored commands for generating training data for supervised learning for training a neural network to identify, from digital images of objects, locations of the objects for interacting with the objects, the commands, when executed by a processor, causing the processor to perform the following steps:
acquiring, for each of a plurality of training objects, at least one respective digital reference image and a plurality of respective further images of the training object;
for each training object of the plurality of training objects:
specifying at least one location of the training object,
mapping the at least one respective reference image onto a descriptor image,
identifying descriptors of the at least one specified location,
mapping the respective further images of the training object onto further descriptor images, and
determining locations in the respective further images by locating points in the further images, the descriptors of which in the further descriptor images correspond to the identified descriptors of the at least one specified location; and
generating the training data for supervised learning by marking the determined locations for the respective further images of the training objects.
